(19) United States
(12) Patent Application Publication
(10) Pub. No.: US 2011/0277587 A1
(43) Pub. Date: Nov. 17, 2011

(54) Variable inertia flywheel

(76) Inventor: Patrick J. Dugas, Winter Haven, FL (US)

(21) Appl. No.: 13/136,064

(22) Filed: Jul. 22, 2011

Related U.S. Application Data
(63) Continuation-in-part of application No. 11/833,611, filed on Aug. 3, 2007, now abandoned.

(51) Int. Cl. F16F 15/173

(52) U.S. Cl. 74/573.1

(57) ABSTRACT

The variable inertia flywheel is a wheel on an axle with a toroidal hollow tubular rim that is completely filled with a fluid. The tubular rim contains one of more one-way valves that allow the fluid to pass in the opposite direction of rotation. When torque is applied to the axle the wheel accelerates but the fluid lags in acceleration. The wheel has two components of inertia, the solid material of wheel and the fluid. The fluid lag lowers the effective moment of inertia of the total system compared to a solid flywheel of the same mass. After a period of time the fluid acquires the same speed as the wheel. The one way valves close on deceleration. The wheel now operates as a solid flywheel of the same total mass to deliver energy to the load.

This application is a continuation-in-part of U.S. patent application Ser. No. 11/833,611 filed Aug. 3, 2007.

### TECHNICAL FIELD

This invention relates to flywheels, particularly variable inertia flywheels, and their use in storing and then releasing kinetic energy to meet changing power load demands.

### BACKGROUND OF THE INVENTION

Flywheels are made in a variety of shapes and sizes, and of a variety of materials depending on the application in which the flywheel will be used. A flywheel may be a solid cylinder of any diameter and thickness. Many solid flywheels are thinner near the center of the flywheel and thicker near the perimeter to position the greatest mass at the perimeter of the flywheel. A flywheel also may consist of an outer rim connected to a central hub by spokes. Other configurations of flywheels also have been used. Flywheels may be designed to operate in a horizontal or vertical position. Flywheels generally are constructed of metal, such as various grades of steel, aluminum, sintered aluminum, and other metals, or of non-metallic materials or composites, such as carbon fiber, carbon/epoxy, fiberglass/epoxy, KEVLAR®/epoxy, E-GLASS®/epoxy, and other composites. The configuration of the flywheel and the materials used are determined by the requirements of the application in which the flywheel will be used.

Variable inertia flywheels are utilized in rotation machinery to store energy that may be released quickly to meet a sudden energy demand. Variable inertia flywheels frequently are used with machines that are called upon to do considerable work, but in which the work demand is not constant. Known variable inertia flywheels vary inertia by interconnecting multiple flywheels having different inertia, or by moving a mass connected with the flywheel radially with respect to the axis of rotation. The moveable mass can be a solid or a liquid.

In the case of multiple interconnecting flywheels, complicated gearing and transmission systems are required to control the moment of inertia of each flywheel and transfer the angular momentum from at least one flywheel to an output shaft. Solid masses may be moved slidably toward or away from an axis, for example, by centrifugal force, with a spaced chain pulley having the solid masses attached, other mechanical apparatus, or hydraulic pressure. In the case of the liquid mass, movement generally is facilitated, for example, by use of an electromechanical, electromagnetic, oil, or other type pump.

The more moving parts in any apparatus, the greater the chance of failure during operation of the apparatus. In addition, known mechanical and electromechanical devices lack responsiveness when dealing with a sudden increase in demand for power.

### DESCRIPTION OF THE PRIOR ARTS

U.S. Pat. No. 4,335,627 issued to Maxwell on Jun. 22, 1982 discloses a hydraulic flywheel which varies the moment of inertia by increasing of the fluid in one hollow structure and decreases the fluid in another by separating the structures and releasing the fluid. As the fluid is introduced into the hollow structure, centrifugal force causes it to flow to the peripheral regions of the hollow structure. As the fluid accumulates within the hollow structure the moment of inertia of the flywheel increases.

U.S. Pat. No. 4,735,382 issued to Pinson on Apr. 5, 1988 uses a pair of annular rotating housings mounted on a shaft. The housings include individual compartments having a fill and a drain line connected to a pump. The compartments receiving material which is compartmentalized to accurately control the mass distribution during the rotation of the housing for maintaining speed as energy is withdrawn or generated.

U.S. Pat. No. 4,928,553 issued to Wagner on May 29, 1990 uses a complicated gearing and transmission system along with two pairs of variable inertia flywheels, one pair for energy storage and transfer and the second pair for control of inertia.

U.S. Pat. No. 6,883,399 B2 issued to Burstall on Apr. 26, 2005 uses electrical hydraulic pumps to move a fluid between chambers to vary inertia.

U.S. Pat. No. 4,069,669 issued to Pitkanen on Jan. 24, 1978 uses an inertial turbine system which stores energy in a rotating flywheel shell by passing a fluid, such as mercury, in and out of the shell during braking or acceleration of a vehicle in which the system is installed.

Although the above five patents are variable inertia flywheels, the methods to vary the moment of inertia are very different from subject patent which relies on the action of liquid passing thru a one-way restriction valve.

U.S. Pat. No. 4,282,948 issued to Jerome on Aug. 11, 1981 discloses a motor vehicle propulsion system wherein a small engine drives a liquid filled flywheel to store kinetic energy in the liquid. Power is transferred to the vehicle propulsion wheels on driver demand by releasing the liquid, through nozzles by a manually operated valve controller system, to a turbine which is connected to the drive wheels through a drive train. Jerome's flywheel and turbine assembly rotate independently of each other and Jerome provides no operational way to seal the union between the flywheel and turbine for the liquid to be retained in the system. Other problems with Jerome's include: no provision for filling the flywheel, only an opening that returns the liquid from the turbine back into the flywheel; the liquid to be released through the nozzles would be slung out by centrifugal force only and not under any pressure, so any energy transferred to the turbine would be minimal at best, lacks any workable way to recapture the liquid that “falls to the bottom of the turbine and returns through the channel to the center of the flywheel”; any seal, that Jerome made no provision for between the flywheel and turbine, would create a substantial friction drag and related overheating problems. Furthermore, this patent does not attempt to vary the moment of inertia, nor is it a variable inertia flywheel. And, while it incorporates similar parts as subject patent, the objective, operation and accomplished results vary greatly.

### SUMMARY

In contrast to the prior art variable inertia flywheels, the variable inertia flywheel of the present invention comprises a very simple device having few moving parts. The liquid moveable mass incorporated in the present invention is moved by the centrifugal force and friction within the rotating flywheel body.

The flywheel of the present invention has a liquid chamber disposed around the periphery of the flywheel. The liquid chamber is equipped with one or more symmetrically spaced filling holes for introducing a liquid into the liquid chamber and expelling air there from, with corresponding counter balance weights as appropriate to maintain rotational balance. The liquid chamber also is fitted with one or more symmetrically spaced one-way restriction valves that allow the liquid to flow in the direction opposite of rotation of the flywheel body, again with corresponding counter balance weights as appropriate. When the flywheel encounters increased load conditions and slows its rate of rotation, the movement of the liquid closes the one-way restriction valves and prevents the liquid from slowing down or reversing direction. Thus, the kinetic energy stored in the liquid is released to meet the increased load demand.

Optionally, one or more manually adjustable vanes also may be attached by a central pin to the front and rear surfaces of the liquid chamber of the flywheel in a manner such that the manually adjustable vanes protrude into the liquid chamber at an adjustable angle. This manually adjustable vane system comprises a central pin, stem, stem seal, handle and a lock. The flywheel of the present invention also may contain multiple independent liquid chambers. The variable inertia flywheel of the present invention is suitable for use in all applications in which flywheels in general are used.

### BRIEF DESCRIPTION OF THE DRAWINGS

FIGS. 1a and 2a show lateral views of the flywheel with one type of a one-way restriction valve in accordance with one embodiment.

FIGS. 1b and 2b are cross-sectional views of the flywheel showing the embodiments of FIGS. 1a and 2a respectively.

FIGS. 3a and 4a show lateral views of the flywheel with another type of a one-way restriction valve in accordance with another embodiment.

FIGS. 3b and 4b are cross-sectional views of the flywheel showing the embodiments of FIGS. 3a and 4a respectively.

FIG. 5 illustrates four types of one-way restriction valves suitable for use in the present invention.

FIG. 6a shows a lateral view of the flywheel with adjustable vanes in the open position in accordance with another embodiment.

FIG. 6b is a lateral view of the flywheel with adjustable vanes in a partially closed position.

FIG. 6c is an exploded view of FIG. 6b at line 6c to 6c of the adjustable vane in a partially closed position.

### DETAILED DESCRIPTION OF THE PREFERRED EMBODIMENTS

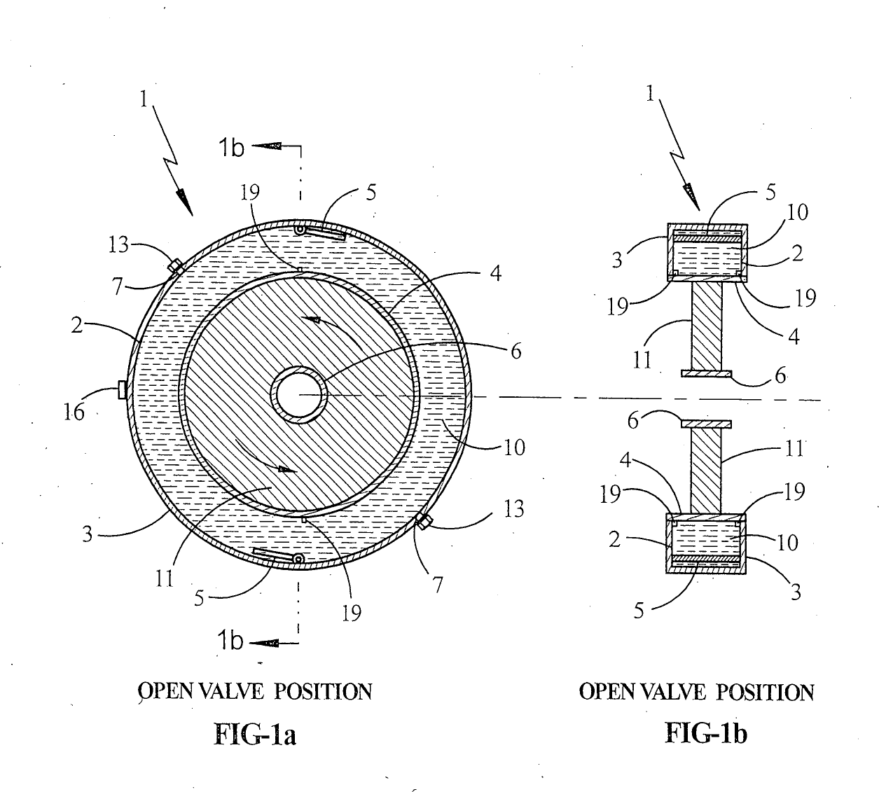

As shown in the Figures, the flywheel 1 of the present invention is a very simple device with few moving parts. One embodiment of the flywheel 1 is illustrated in FIGS. 1a and 1b. Beginning in the center of the flywheel 1 is a central mounting hub 6 ready to accept a rotational power source (not shown). The central mounting hub 6 is attached to the flywheel body 11, and the flywheel body 11 can be a solid disc (as shown) or spokes and constructed of any known materials suitable for the application in which it is used. A liquid chamber 2 is disposed around the periphery of the flywheel body 11 and may be of any convenient shape that will allow the liquid to flow freely. For example, the circular shape shown in FIG. 1 has a rectangular cross section, but could be a toroidal or doughnut shape having a circular cross section (not shown in the drawings). The liquid chamber 2 comprises an inner wall 4 and an outer wall 3. Attached on the inside surface of the outer wall 3 within the liquid chamber 2 is at least one one-way restriction valve 5. The one-way restriction valve 5 is attached to the inside surface of an outer wall 3 at a point of greatest radius from the center of the flywheel 1. Valve Seat 19 is attached to inner wall 4 at shortest distance from outer wall 3 to provide a seal for restriction valve 5 in closed position. A liquid 10 completely fills the inside of the liquid chamber 2. The outer wall 3 of the liquid chamber 2 includes at least one filling hole 7 to introduce the liquid 10 into the liquid chamber 2. The filling hole 7 is sealed by a closure such as a plug 13. Attached to the outside surface of the outer wall 3 is at least one counter balance weight 16.

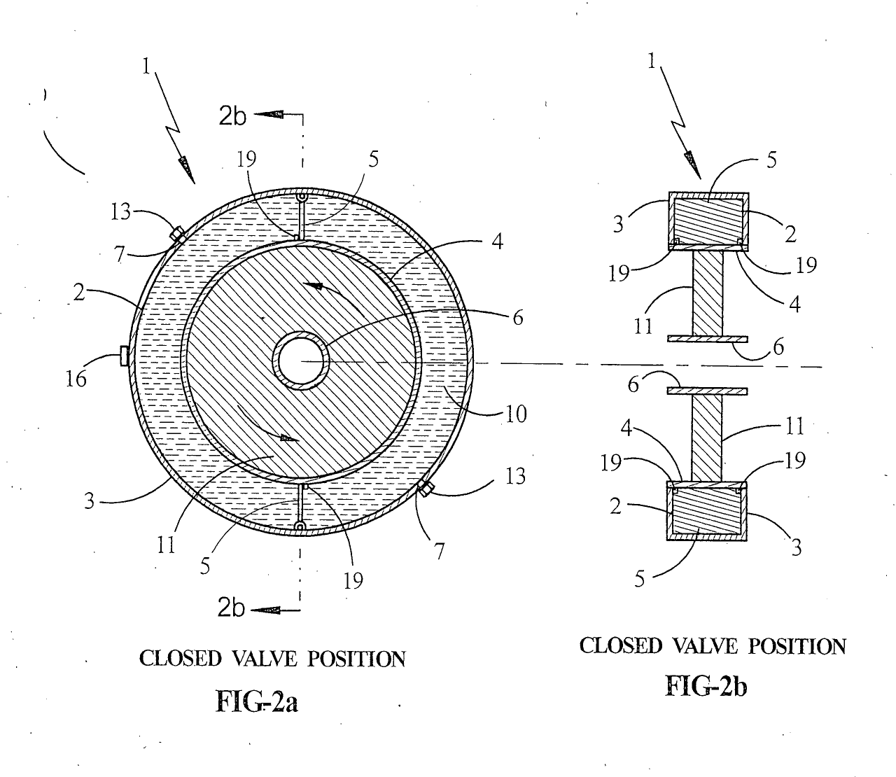

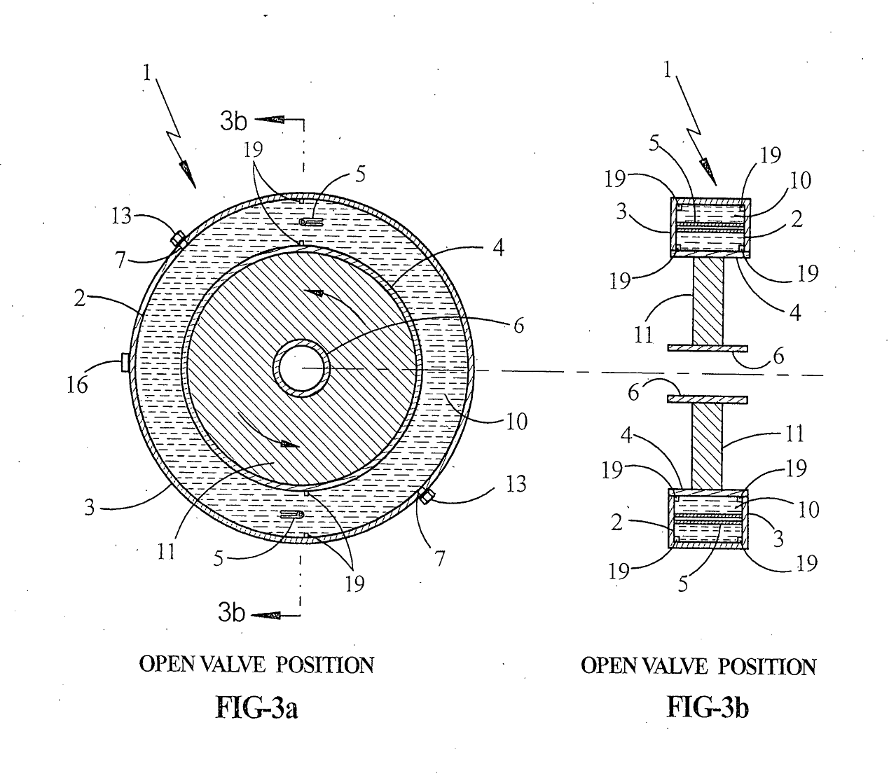

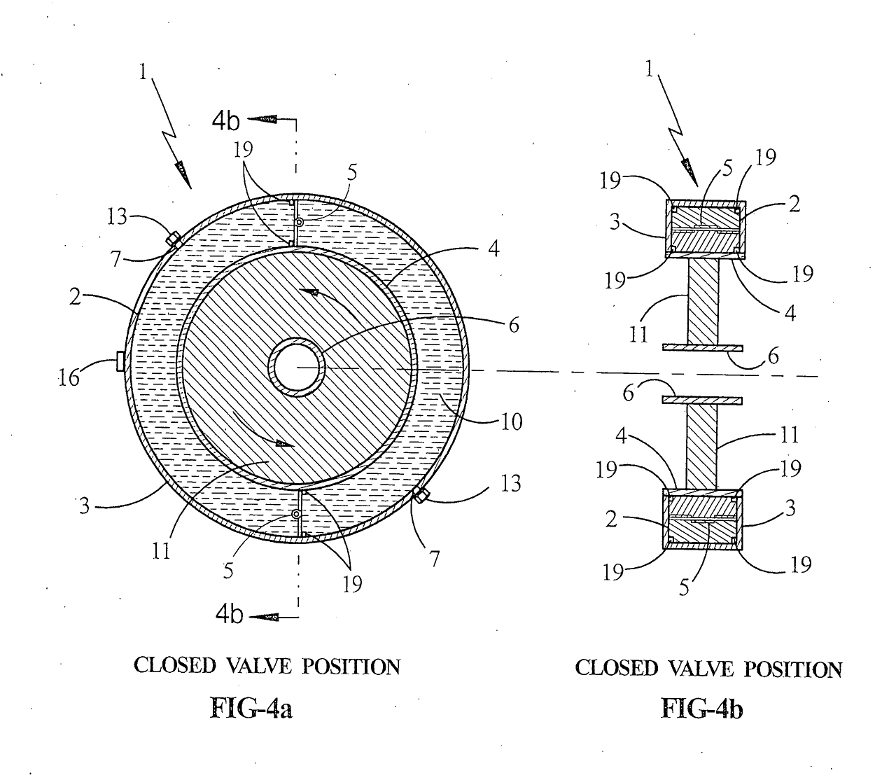

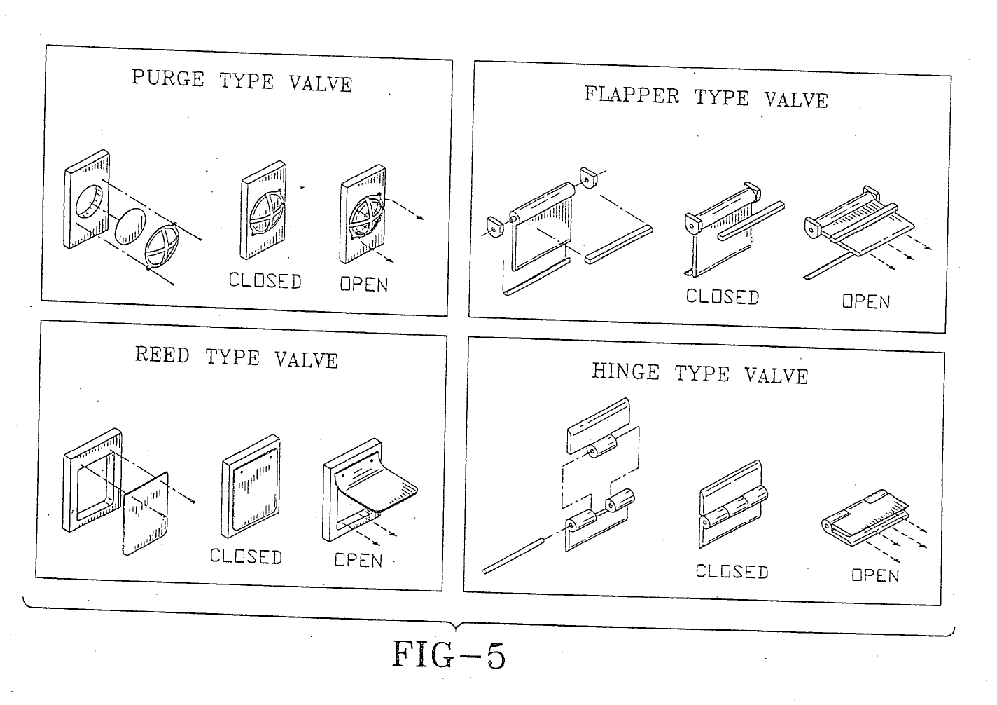

In this embodiment, FIGS. 1a and 1b illustrate the one-way restriction valve 5 in an open valve position. FIGS. 2a and 2b illustrate the same embodiment as previously described shown in the closed position. Another embodiment of the flywheel 1 is illustrated in FIGS. 3a and 3b. All previously described parts illustrated in FIGS. 1a and 1b are the same in this embodiment except for illustrating a different type of one-way restriction valve 5. In this embodiment the one-way restriction valve 5 is attached to the inside walls of the outer wall 3 so that the one-way restriction valve 5 is placed in the center of the liquid chamber 2, and is illustrated in an open valve position. FIGS. 4a and 4b are the same embodiment as FIGS. 3a and 3b except that the one-way restriction valve 5 illustrates closed valve position against valve seat 19. FIG. 5 illustrates types of one-way restriction valves 5 suitable for use with the flywheel 1, illustrated in each of the other figures.

The one-way restriction valve 5 may be of any known configuration. The one-way restriction valve 5 may, be constructed of any material suitable for the type of valve being used and the application in which the flywheel will be used. For example, a flapper or hinge valve would be constructed of an inflexible material having sufficient strength to resist the combined mass of the contained liquid 10. For example, metals, hard plastics, carbon fiber, various composites, or other materials may be used so long as such materials are both inflexible and resistant to the liquid 10 used to fill the liquid chamber 2. FIG. 5 show purge or reed valves which would be constructed of a soft plastic or elastomeric material such as ABS (acrylonitrile butadiene styrene), PVC (polyvinyl chloride), CPVC (chlorinated polyvinyl chloride), PE (polyethylene), PVDF (polyvinylidene floride), or other materials so long as such materials are both flexible and resistant to the liquid 10 used to fill the liquid chamber 2. Other types of one-way restriction valves 5 also may be used.

During acceleration, as shown in FIGS. 1, 2, 3 and 4 which is in a counter clockwise direction, the flywheel 1 initially rotates at a greater speed than the liquid 10 and the movement of the one-way restriction valve 5 through the liquid 10 forces the one-way restriction valve 5 open. At a steady rotational speed of the flywheel 1, the liquid 10 and the flywheel 1, rotate at the same speed and the one-way restriction valve 5 stays open. When the flywheel 1 decelerates, for example when additional load is applied to the flywheel body 11, the movement of the liquid 10 against the one-way restriction valves 5 causes the one-way restriction valves 5 to close against valve seat 19 so that the liquid 10 is trapped, and now rotates at the same rotational speed as the flywheel body 11, thus combining the kinetic energy stored in the liquid 10 with that of the flywheel 1 to meet the additional load demands and maintain the speed of the inertia flywheel 1. The greater the ratio of the weight of liquid to the weight of solid in the inertia flywheel 1 the greater the efficiency of the flywheel.

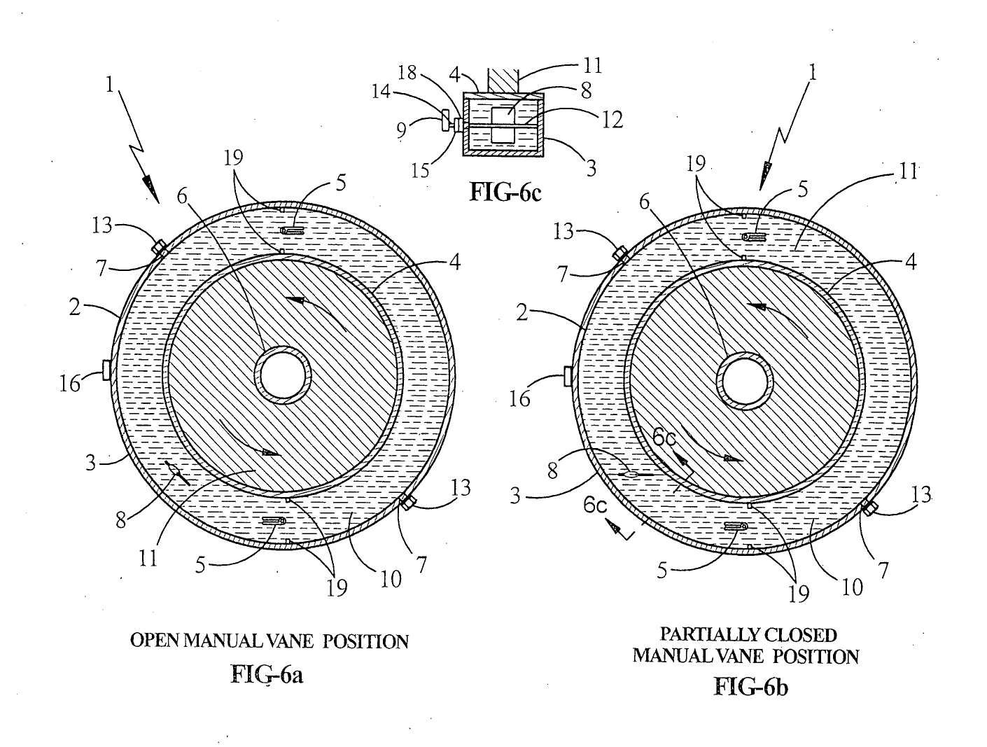

Optionally one of more manually adjustable vanes 8 also may be attached by a central pin 12 to the front and rear surfaces of the liquid chamber 2 of the flywheel body 11, as shown in FIGS. 6a and 6b. Each manually adjustable vane 8 includes a mechanism for adjusting the angle of the adjustable vane 8 within the liquid chamber 2. This mechanism is accessible from the exterior of the flywheel body 11 as shown in FIG. 6c and comprises a stem 14 and stem seal 18 that is exterior to the flywheel body 11 and has a knurled knob, paddle shaped blade, or other handle 9 for adjusting the angle of the manually adjustable vane 8 within the liquid chamber 2. This mechanism also comprises a lock 15 to lock the manually adjustable vane 8 at the desired angle within the liquid chamber 2. The manually adjustable vanes 8 protrude into the liquid chamber 2 at an adjustable angle and push against the liquid 10 at the same speed of rotation as the flywheel body 11. Thus, these manually adjustable vanes 8 assist the liquid 10 to accelerate more rapidly to the rotational speed of the flywheel 1. More rapid acceleration of the liquid 10 is useful in situations where the flywheel 1 and the liquid 10 need to reach the same rotational speed more rapidly, for example, when it is known that the load on the flywheel will increase soon after the flywheel begins to rotate.

Optionally, the flywheel 1 of the present invention may contain multiple independent liquid chambers (not shown in drawings). If each of the multiple independent liquid chambers holds less liquid than one single chamber, but the total weight of the liquid 10 in both cases is the same, the total liquid 10 in the multiple independent chamber flywheel will accelerate to the rotational velocity of the flywheel faster than the liquid 10 in the single chamber, because the liquid 10 in the multiple independent chambers is exposed to a greater surface area, and therefore to greater frictional effects than the liquid 10 in just one chamber. Each of the multiple independent chambers may be filled with the same liquid or with different liquids.

The flywheel 1 of the present invention having a liquid chamber 2 and one-way restriction valves 5 and valve seat 19 requires less energy to attain its desired steady rotational speed than a traditional solid flywheel, because the liquid 10 in the liquid chamber 2 slides over the surrounding surfaces as the flywheel body 11 begins to rotate requiring significantly less energy for the flywheel body 11 to attain optimum speed. Near or at optimum speed the liquid 10 is rotating at the same speed as the flywheel body 11 due to the action of friction and centrifugal forces upon the liquid 10. The flywheel 1 of the present invention that also has manually adjustable vanes 8 will require a minimal increase in start-up energy than a flywheel without the manually adjustable vanes 8, but will accelerate to the rotational speed of the flywheel 1 more rapidly. Existing traditional flywheels may be retrofitted with an external peripheral liquid chamber 2 and one-way valves 5 and valve seat 19 which will significantly increase the stored kinetic energy of the flywheel while requiring only a minimal increase in start-up energy.

The variable inertia flywheel of the present invention is suitable for use in all applications in which flywheels in general are used, for example, with internal combustion engines, continuously variable transmissions, and electrical power generation equipment among others.

While the present invention has been described in terms of a general embodiment with several specific modifications, it is recognized that persons skilled in this art will readily perceive many other modifications and variations in the embodiments described above. Such modifications and embodiments are included within the scope of the present invention.

Parts are depicted and numbered as follows in one or more of the figures:
1 flywheel;
2 liquid chamber;
3 outer wall;
4 inner wall;
5 one-way restriction valve;
6 central mounting hub;
7 filling hole;
8 manually adjustable vane;
9 handle;
10 liquid;
11 flywheel body;
12 central pin;
13 plug;
14 stem;
15 lock;
16 counter balance weight;
17 omitted on purpose;
18 stem seal;
19 valve seal;

What is claimed is:

1. A variable inertia flywheel comprising:
a central mounting hub for mounting the flywheel to a rotational power source;
a flywheel body attached to central mounting hub;
a liquid chamber disposed around the periphery of the flywheel body having an outer wall and an inner wall;
at least one one-way restriction valve attached to the inside surface of outer wall;
a liquid completely filling the inside of the liquid chamber;
at least one filling hole in outer wall to introduce liquid into liquid chamber;
a plug to seal filling hole;
one or more valve seats attached to inner wall to provide a seal for the one-way restriction valves.

2. The flywheel of claim 1 including at least one counter balance weight attached to outer wall.

3. The flywheel of claim 1 including one or more manually adjustable vanes to increase friction against liquid at start up/acceleration of rotation of flywheel.

4. Flywheel of claim 3 where components of manually adjustable vane are comprised of a handle a central pin a stem a lock and a stem seal.

5. A means for capturing and storing increments of rotational energy in a flywheel by automatically lowering the effective moment of inertia during acceleration and automatically raising the effective moment of inertia under load.

6. A method to automatically lower the moment of inertia in a flywheel during acceleration and automatically raising the moment of inertia of a flywheel under load.
